(19) United States
(12) Patent Application Publication
(10) Pub. No.: US 2005/0229048 A1
(43) Pub. Date: Oct. 13, 2005

(54) Caching operational code in a voice markup interpreter

(75) Inventors: William V. Da Palma, Coconut Creek, FL (US); Brett J. Gavagni, Coconut Creek, FL (US); Matthew W. Hartley, Boynton Beach, FL (US); Brien H. Muschett, Palm Beach Gardens, FL (US)

Correspondence Address: CHRISTOPHER & WEISBERG, PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/812,540

(22) Filed: Mar. 30, 2004

(51) Int. Cl. G06F 11/00

(52) U.S. Cl. 714/100

(57) ABSTRACT

A method, system and apparatus for caching operational code in a voice markup interpreter. A method of processing script logic embedded in voice markup can include the step of transforming a script embedded in voice markup to an object representation of a compiled form of the script. Subsequently, the object representation can be cached so that the cached object representation can be retrieved and accessed in lieu of compiling the script. Notably, the transforming step can be performed when parsing the script in a voice markup interpreter.

### BACKGROUND OF THE INVENTION

1. Statement of the Technical Field

The present invention relates to the field of voice markup processing, and more particularly to the caching and execution of operational code disposed within a voice markup application.

2. Description of the Related Art

Voice markup processing provides a flexible mode for handling voice interactions in a data processing application over a computer communications network. Specifically designed for deployment in the telephony environment, voice markup provides a standardized way for voice processing applications to be defined and deployed for interaction for voice callers over the public switched telephone network (PSTN). In recent years, the VoiceXML specification has become the predominant standardized mechanism for expressing voice applications.

While voice markup applications initially had been limited to essential text-to-speech prompting and audio playback, more recent voice markup applications include basic forms processing. Yet, as it would be expected, the demands of advancing telephonic applications require more than simplistic forms and prompting. Accordingly, scripting capabilities have been incorporated into voice markup standardized implementations, much as scripting capabilities have been incorporated into visual markup standardized implementations.

The scripting support in VoiceXML provides the developer with the capability to process input validation and filtering, calculations, and parsing and reformatting of data in the VoiceXML gateway. Although these same functions could also be performed in the server, the overhead of the transaction with the server may dominate the time spent in performing the function. In addition, the actual interaction with the application server itself may involve much more than a simple common gateway interface execution, and might also include transaction handling, session management, and so on, even for such a simple request. Presently, the European Computer Manufacturer's Association (ECMA) standard for a scripting language for use in VoiceXML is known as ECMAScript.

Like the processing of other markup language documents, the processing of voice markup can benefit substantially—from the performance perspective—from caching strategies. Specifically, to the extent that often used markup language documents can be accessed from the cache rather than from fixed storage, the apparent and actual responsiveness of the voice application will demonstrate substantial improvements. Nevertheless, the performance advantage of caching markup can be negated by the inherent processing latencies associated with the compilation of embedded program code in a markup language document.

Several generalized solutions have been proposed to address the difficulty in compiling operative code embedded in markup in a resource limited client. For instance, in the United States Patent Application No. U.S. 2002/0120940 A1, filed on behalf of Pierre Willard on Feb. 1, 2002 and published on Aug. 29, 2002, it is proposed to pre-compile Javascript embedded in HTML in the server before transmitting the compiled object over a cable television distribution network to one or more set top boxes. In this way, the resource expensive process of compilation can be performed outside of the client browser.

In contrast, in the United States Patent Application No. U.S. 2002/0191756 A1 filed on behalf of David Guedalia et al. on Jun. 18, 2001 and published on Dec. 19, 2002, while it is proposed to compile VoiceXML documents themselves into binary form, once compiled the binary form of the VoiceXML documents can be cached for subsequent retrieval without requiring re-compilation of the VoiceXML documents. Notwithstanding, the Guedalia publication provides no guidance on the handling of programmatic scripts which may be embedded within a VoiceXML document, for example ECMAScript.

### SUMMARY OF THE INVENTION

The present invention addresses the deficiencies of the art in respect to compiling and caching program code in voice markup and provides a novel and non-obvious method, system and apparatus for caching operational code in a voice markup interpreter. A method of processing script logic embedded in voice markup can include the step of transforming a script embedded in voice markup to an object representation of a compiled form of the script. Subsequently, the object representation can be cached so that the cached object representation can be retrieved and accessed in lieu of compiling the script.

Notably, the transforming step can be performed when parsing the script in a voice markup interpreter. In a preferred aspect of the invention, the transforming step can include the steps of parsing the script to correlate scripted operations and data with machine interpretable instructions and data, and wrapping the machine interpretable instructions and data into a programmatic object. In any case, the method also can include the step of validating the script before performing the transforming step. Finally, the object representation can be compressed before performing the caching step.

In accordance with the present invention, a voice markup interpreter can include a script processor having a parser, compiler and object builder. Additionally, a cache can be coupled to the script processor. Importantly, the object builder can include program logic configured to transform script instructions embedded in voice markup to a cacheable object representation of a compiled form of the script instructions. Moreover, a compressor can be included and placed under control of the script processor for compressing object representations produced for insertion in the cache.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system, method and apparatus for compiling and caching programmatic script embedded in voice markup; and,

FIG. 2 is a flow chart illustrating a process for compiling, caching and retrieving for execution programmatic script embedded in voice markup.

### DETAILED DESCRIPTION OF THE PREFERRED EMBODIMENTS

The present invention is a method, system and apparatus for compiling and caching programmatic script embedded in voice markup. In accordance with the present invention, programmatic script embedded in voice markup can be identified for processing in a voice markup language interpreter. When the interpreter engages in a parsing and validation phase of the embedded script, an object can be created which represents a compiled form of the resource defined by the embedded script. In this regard, the created object can include operative functionality which corresponds to the operative functionality defined by the script. The created object, acting as a representation of the embedded script, subsequently can be compressed and cached for retrieval at a later time.

In operation, when a request is processed by the voice markup interpreter which causes the retrieval of the voice markup either from disk storage or from the cache, the cached object representation of the compiled script also can be retrieved from the cache. Using the object representation, the operable functionality of the object representation can be interpreted in place as if the embedded script had been re-compiled and interpreted by the voice markup interpreter. Yet, by utilizing a cached object representation of the script, the script need not be re-parsed and re-compiled, thereby generating a significant performance advantage over previous method of processing voice markup.

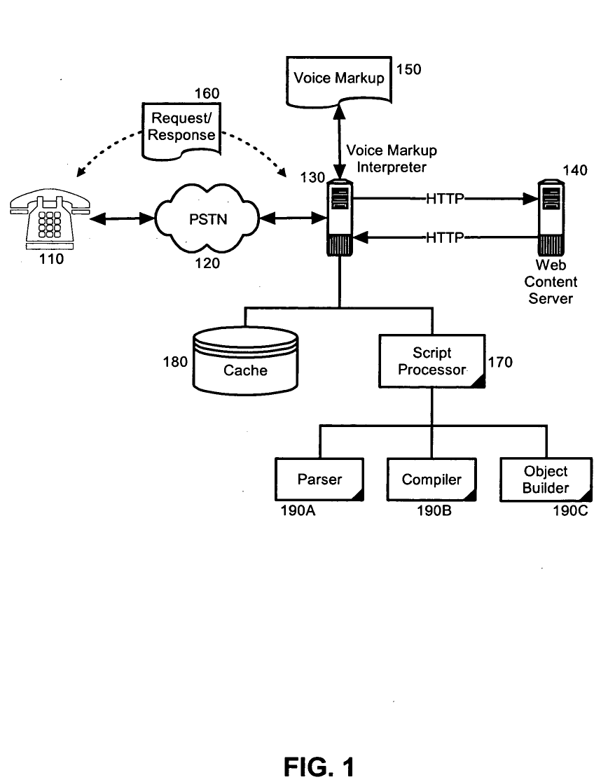

In further illustration of the foregoing inventive arrangements, FIG. 1 is a schematic illustration of a system, method and apparatus for compiling and caching programmatic script embedded in voice markup. The voice markup processing system can include a voice markup interpreter 130 configured for communicative linkage to one or more voice clients 110 over the PSTN 120. Though not shown, the voice markup interpreter 130 further can be configured for communicative linkage to one or more voice clients over a data communications network where the voice clients have been configured for telephonic access using the data communications network, as is well-known in the IP telephony art.

The voice markup interpreter 130 can be programmed for standalone processing of voice markup 150. The voice markup interpreter 130 further can be configured for cooperative processing between the voice markup 150 and data content provided by a content server 140 coupled to the voice markup interpreter 130. In either circumstance, the voice markup interpreter 130 can be configured to process requests and responses 160 from and to the voice clients 110 as defined according to the voice markup 150. Notably, one or more operative scripts can be embedded in the voice markup 150. The operative scripts can programmed for interpretation by a script processor 170 to perform programmed operations as is known in the art of ECMAScript.

In accordance with the present invention, the script processor 170 can be configured both to access program objects from a cache 180 and also to insert cacheable program objects into the cache 180. To that end, the script processor 170 can include a parser 190A, a compiler 190B, and an object builder 190C. The parser 190A can parse identifiable script in voice markup 150 in preparation for compilation. The compiler 190B can compile the parsed script into a validated object representation of the script. Finally, the object builder 190C can build a cacheable and compressible object from the compiled object representation, suitable for persistence in the cache 180. Importantly, the compiler 190B and the object builder 190C can produce an object representation of the compiled object that otherwise would be produced from the script for direct interpretation, and not a direct, un-cacheable compilation of the script.

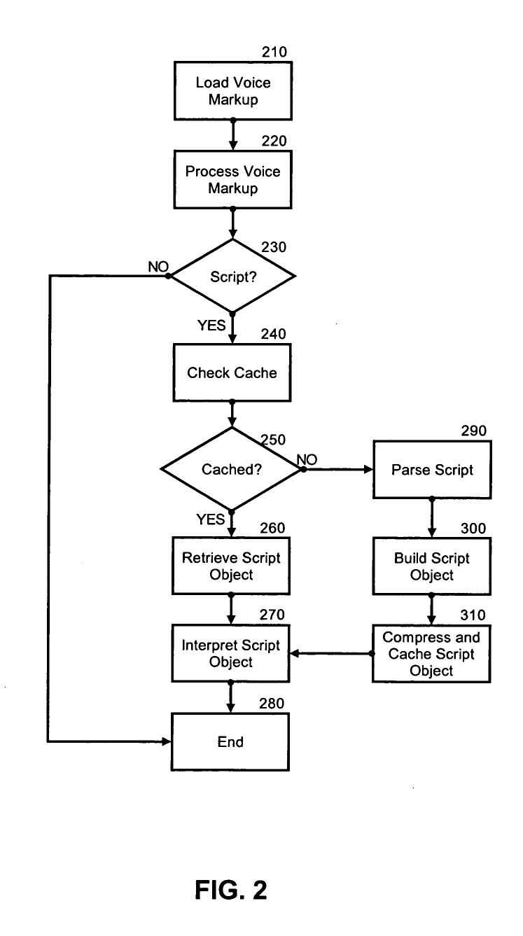

In further explanation, FIG. 2 is a flow chart illustrating a process for compiling, caching and retrieving for execution programmatic script embedded in voice markup. Beginning in block 210, a voice markup document can be loaded. A voice markup document can include, for example, a document having instructions which conform to the VoiceXML specification. In block 220, the voice markup can be processed by the voice markup interpreter. In decision block 230, it can be determined whether the voice markup includes an embedded script defining operational logic or code, for instance ECMAScript. If not, the process can end in block 280. Otherwise, the process can continue through block 240.

In block 240, the cache can be queried to determine whether an object representation of a compiled form of the script already exists in the cache. If so, in block 260 the cached object representation of the compiled form of the script can be retrieved from the cache and in block 270 the object representation can be interpreted directly. Significantly, by interpreting the cached object representation directly, the voice markup interpreter need not compile the actual script embedded in the voice markup, thereby avoiding substantial latencies and resource consumption associated with a conventional compilation step.

In any case, if in decision block 250 the object representation for the compiled form of the script cannot be located in the cache, in block 290 the script can be parsed in preparation for compilation. Subsequently, in block 300, an object representation of a compiled form of the script can be validated and created. In particular, the object representation can include the logic that otherwise would be incorporated in a compiled form of the script. The logic can be wrapped in one or more methods within a class object, for example, such that the methods can be accessed by external objects when loaded to memory. Importantly, however, the object representation can be compressible and cacheable unlike known compiled forms of script found in voice markup. To that end, in block 310, the object representation can be compressed and cached. Finally, the object representation can be interpreted in block 270 before the process can end in block 280.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method of processing script logic embedded in voice markup, the method comprising the steps of:
transforming a script embedded in voice markup to an object representation of a compiled form of said script;
caching said object representation; and,
retrieving and accessing said cached object representation in lieu of compiling said script.

2. The method of claim 1, further comprising the step of performing said transforming step when parsing said script in a voice markup interpreter.

3. The method of claim 1, further comprising the step of validating said script before performing said transforming step.

4. The method of claim 1, further comprising the step of compressing said object representation before performing said caching step.

5. The method of claim 1, wherein said transforming step comprises the steps of:
parsing said script to correlate scripted operations and data with machine interpretable instructions and data; and,
wrapping said machine interpretable instructions and data into a programmatic object.

6. A voice markup interpreter comprising:
a script processor having a parser, compiler and object builder; and,
a cache coupled to said script processor,
said object builder comprising program logic configured to transform script instructions embedded in voice markup to a cacheable object representation of a compiled form of said script instructions.

7. The voice markup interpreter of claim 6, further comprising a compressor under control of said script processor for compressing object representations produced for insertion in said cache.

8. A machine readable storage having stored thereon a computer program for processing script logic embedded in voice markup, the computer program comprising a routine set of instructions which when executed by a machine cause the machine to perform the steps of:
transforming a script embedded in voice markup to an object representation of a compiled form of said script;
caching said object representation; and,
retrieving and accessing said cached object representation in lieu of compiling said script.

9. The machine readable storage of claim 8, further comprising the step of performing said transforming step when parsing said script in a voice markup interpreter.

10. The machine readable storage of claim 8, further comprising the step of validating said script before performing said transforming step.

11. The machine readable storage of claim 8, further comprising the step of compressing said object representation before performing said caching step.

12. The machine readable storage of claim 8, wherein said transforming step comprises the steps of:
parsing said script to correlate scripted operations and data with machine interpretable instructions and data; and,
wrapping said machine interpretable instructions and data into a programmatic object.
